(19) United States
(12) Patent Application Publication
(10) Pub. No.: US 2026/0257889 A1
(43) Pub. Date: Sep. 3, 2026

(54) ELEVATOR SYSTEM

(71) Applicant: Mitsubishi Electric Corporation, Tokyo (JP)

(72) Inventors: Yuichi KAJIYAMA, Tokyo (JP); Kazunori WASHIO, Tokyo (JP); Eiji YOKOYAMA, Tokyo (JP)

(73) Assignee: Mitsubishi Electric Corporation, Tokyo (JP)

(21) Appl. No.: 18/846,665

(22) PCT Filed: Mar. 30, 2022
(86) PCT No.: PCT/JP2022/016173

§ 371 Date: Sep. 13, 2024

(51) Int. Cl. B66B 1/40; B66B 1/34

(52) U.S. Cl. CPC B66B 1/40; B66B 1/3492

(57) ABSTRACT

An elevator system includes, for example, a tape, a sensor, a correction plate, a sensor, a motion control unit, a setting unit, and a calculation unit. The setting unit sets a standard correction amount for a standard position code on the basis of a detection result of the correction plate by the sensor when a car stops at a standard floor by control by the motion control unit. The calculation unit calculates a correction amount for each position code attached to the tape on the basis of the standard correction amount set by the setting unit. The motion control unit controls movement of the car on the basis of the position codes read by the sensor and correction amounts calculated by the calculation unit.

### TECHNICAL FIELD

The present disclosure relates to an elevator system.

### BACKGROUND ART

PTL 1 discloses an elevator device. The elevator device disclosed in PTL 1 includes a first tape for detecting a position of a car. The first tape is laid out vertically across a shaft. A reading device for reading position information attached to the first tape is provided on the car.

The elevator device disclosed in PTL 1 further includes a second tape for detecting a stop position of the car. The second tape is laid out so as to correspond to a stop position of each floor. Stop position information attached to the second tape is read by the reading device.

### CITATION LIST

### Patent Literature

[PTL 1] JP 2021-66567 A

### SUMMARY

### Technical Problem

In the elevator device disclosed in PTL 1, the position of the car is corrected on the basis of the stop position information of the second tape. However, with the elevator device, it is necessary to provide the second tape so as to correspond to the stop position of each floor to correct the position of the car. This causes a problem that a configuration becomes complicated.

The present disclosure is made to solve the problem as described above. An object of the present disclosure is to provide an elevator system capable of correcting a position of a car with a simple configuration.

### Solution to Problem

An elevator system according to the present disclosure is an elevator system in which a car moves in a shaft, the car stops at a plurality of service floors, and part of the plurality of service floors is set as a standard floor. The system comprises a tape which is provided in the shaft and to which position codes are attached over a specific range in which the car can move, a first sensor which is provided on the car and which reads the position codes attached to the tape, a detected object provided in the shaft so as to correspond to a position of the standard floor, a second sensor which is provided on the car and which detects the detected object, a motion control unit that controls movement of the car, a setting unit that sets a standard correction amount for a standard position code on the basis of a detection result of the detected object by the second sensor when the car stops at the standard floor by control by the motion control unit, and a first calculation unit that calculates a correction amount for each of the position codes attached to the tape on the basis of the standard correction amount set by the setting unit. The motion control unit controls the movement of the car on the basis of the position codes read by the first sensor and correction amounts calculated by the first calculation unit. The standard position code is a code set in advance as a code indicating the position of the standard floor among the position codes attached to the tape.

### Advantageous Effects of the Invention

According to an elevator system of the present disclosure, it is possible to correct a position of a car with a simple configuration.

### BRIEF DESCRIPTION OF DRAWINGS

FIG. 1 is a view illustrating an example of an elevator system according to a first embodiment.

FIG. 2 is a view for explaining functions of a correction plate and a sensor.

FIG. 3 is a view for explaining functions of a controller.

FIG. 4 is a flowchart indicating an operation example of the elevator system in the first embodiment.

FIG. 5 is a view illustrating a condition where a car is stopped at a standard floor.

FIG. 6 is a view illustrating another condition where the car is stopped at the standard floor.

FIG. 7 is a view illustrating another condition where the car is stopped at the standard floor.

FIG. 8 is a view for explaining transmission of heat in a shaft.

FIG. 9 is a view for explaining temperature distribution of the shaft.

FIG. 10 is a view for explaining an amount of elongation and shrinkage of a tape.

FIG. 11 is a view for explaining an example of a correction function.

FIG. 12 is a view indicating a difference between a curve and a line indicating the correction function indicated in FIG. 11.

FIG. 13 is a view for explaining another example of the correction function.

FIG. 14 is a view indicating a difference between a curve and a line indicating the correction function indicated in FIG. 13.

FIG. 15 is a view indicating temperature distribution of the shaft measured in an actual elevator device.

FIG. 16 is a view indicating an amount of elongation and shrinkage of the tape calculated from the temperature distribution indicated in FIG. 15.

FIG. 17 is a view for explaining an example of the correction function.

FIG. 18 is a view indicating an example of a correction error.

FIG. 19 is a view indicating a relationship between a detection position by the sensor and a maximum value of an absolute value of the correction error.

FIG. 20 is a view corresponding to FIG. 13.

FIG. 21 is a view corresponding to FIG. 14.

FIG. 22 is a view indicating a relationship between the detection position by the sensor and the maximum value of the absolute value of the correction error.

FIG. 23 is a view indicating a relationship between the detection position by the sensor and the maximum value of the absolute value of the correction error.

FIG. 24 is a view corresponding to FIG. 13.

FIG. 25 is a view corresponding to FIG. 14.

FIG. 26 is a view indicating a ratio of the correction error in each building.

FIG. 27 is a view indicating a calculation example of the correction amount in a case where three standard floors are set.

FIG. 28 is a view for explaining a method for calculating a delay time.

FIG. 29 is a view illustrating an example of hardware resources of the controller.

FIG. 30 is a view illustrating another example of the hardware resources of the controller.

### DESCRIPTION OF EMBODIMENTS

Detailed description will be provided below with reference to the drawings. Redundant description will be simplified or omitted as appropriate. In the respective drawings, the same reference numerals indicate the same portions or the corresponding portions.

### First Embodiment

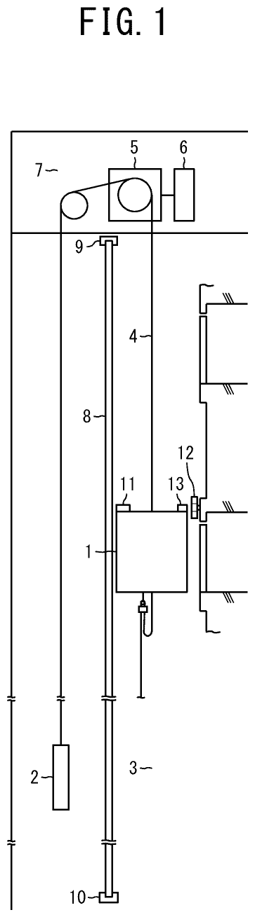

FIG. 1 is a view illustrating an example of an elevator system according to a first embodiment. The elevator system illustrated in FIG. 1 includes a car 1 and a counterweight 2. The car 1 moves up and down in a shaft 3. The car 1 and the counterweight 2 are hung in the shaft 3 by a rope 4. The counterweight 2 moves up and down in the shaft 3 in a direction opposite to a direction in which the car 1 moves. FIG. 1 illustrates an example of an elevator system employing a 1:1 roping system.

The rope 4 is wound around traction machine 5. The traction machine 5 drives the car 1. A controller 6 controls the traction machine 5. In other words, movement of the car 1 is controlled by the controller 6. FIG. 1 illustrates an example where the traction machine 5 and the controller 6 are provided in a machine room 7 above the shaft 3. The traction machine 5 and the controller 6 may be provided in the shaft 3. The traction machine 5 may be provided at the top of the shaft 3 or may be provided at a pit of the shaft 3.

A tape 8 is provided in the shaft 3. The tape 8 is an elongated belt-like member. The tape 8 is preferably laid out in a linear shape vertically across the shaft 3. For example, an upper end portion of the tape 8 is fixed at a support member 9 provided at the top of the shaft 3. A lower end portion of the tape 8 is supported by a support device 10 provided at the pit of the shaft 3. Downward force is acted to the tape 8 by a spring, a weight, or the like, included in the support device 10.

Position codes are attached to the tape 8 over a specific range in which the car 1 can move. The position codes are preferably attached over an entire region in which the car 1 can move. The position codes may be magnetic codes or may be optical codes. Codes of another scheme may be recorded in the tape 8 as the position codes.

A sensor 11 for reading the position codes attached to the tape 8 is provided on the car 1. The elevator system illustrated in FIG. 1 detects a position of the car 1 by directly reading the position code attached to the tape 8 with the sensor 11 instead of indirectly detecting the position of the car 1 on the basis of a signal from an encoder included in the traction machine 5, or the like. In other words, the elevator system illustrated in FIG. 1 includes an absolute positioning system. The sensor 11 transmits a signal in accordance with the read position code to the controller 6.

A table 1 indicates an example of a table TA stored in a storage unit 20 (not illustrated in FIG. 1) of the controller 6. In the table TA, position codes for specific positions in the shaft 3 are registered. As one example, stop position codes are registered in the table TA. The car 1 stops at a plurality of service floors. The stop position codes are codes set in advance as codes indicating respective positions of the service floors among the position codes attached to the tape 8. In the example indicated in the table TA, a stop position code indicating a position of a first floor is “5000”. A stop position code indicating a position of a top floor is “100000”.

TABLE 1

| Service floor | Stop position code | Remarks |
|---|---|---|
| (Top) | 102000 | |
| N-th floor | 100000 | Top floor |
| . | . | |
| . | . | |
| . | . | |
| Second floor | 9000 | |
| First floor | 5000 (Standard | Bottom floor |
| | position code) | (Standard floor) |
| (Bottom portion) | 3000 | |

The table TA is created by a professional engineer, for example, upon installation of the system. The engineer moves the car 1 to a position of each service floor by performing manual operation and registers the position codes read by the sensor 11 at that time in the table TA. The table TA indicates an example where the sensor 11 reads the position code “5000” when the car 1 is positioned so as to correspond to the position of the first floor in the manual operation. The position code indicating a position at a bottom portion below a bottom floor may be calculated from the position code indicating the position of the first floor. As another example, the position code indicating the position of the bottom portion may be a fixed value.

The table TA indicates an example where the sensor 11 reads the position code “100000” when the car 1 is positioned so as to correspond to a position of the N-th floor in the manual operation. The position code indicating a position at the top above the top floor may be calculated from the position code indicating the position of the N-th floor. As another example, the position code indicating the position of the top may be a fixed value. Note that “the car 1 is positioned so as to correspond to the position of the first floor” means that a floor surface of the car 1 is positioned at the same height as a floor surface of a hall of the first floor. The engineer may update the table TA by performing manual operation upon maintenance that is regularly performed.

A correction plate 12 is provided in the shaft 3. A sensor 13 for detecting the correction plate 12 is provided on the car 1. The correction plate 12 is an example of a detected object to be detected by the sensor 13. The correction plate 12 is placed so as to correspond to a position of a specific standard floor. The standard floor is a floor of part of the service floors at which the car 1 stops. For example, the standard floor is one of the service floors and set in advance.

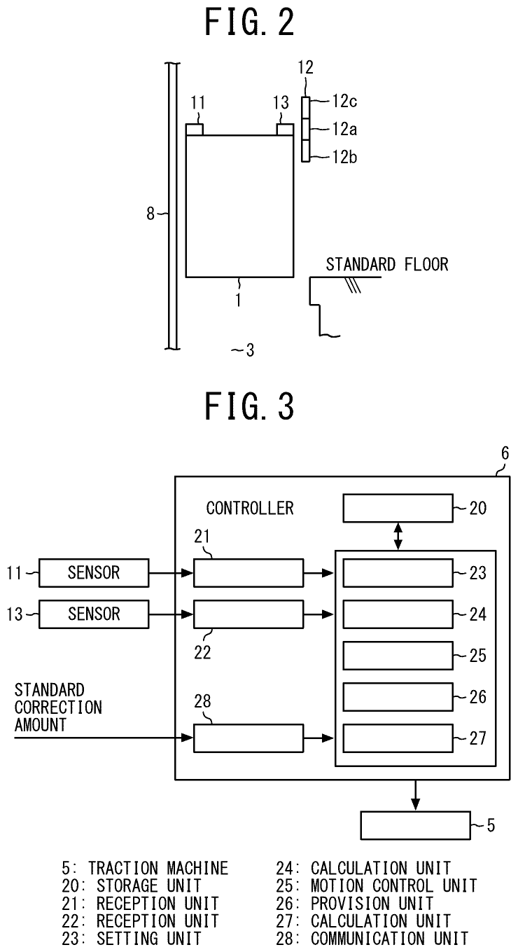

FIG. 2 is a view for explaining functions of the correction plate 12 and the sensor 13. A plurality of zones are set in the correction plate 12. The zones are areas that can be detected by the sensor 13 in a distinguished manner. A preferred example will be described in detail below where three zones of a middle zone 12a, a lower zone 12b immediately below the middle zone 12a, and an upper zone 12c immediately above the middle zone 12a are set in the correction plate 12. Note that the number of zones set in the correction plate 12 may be two. Four or more zones may be set in the correction plate 12.

The correction plate 12 is placed so that the sensor 13 detects the middle zone 12a when the car 1 is positioned so as to correspond to the position of the standard floor. Preferably, the correction plate 12 is placed so that a detection position by the sensor 13 matches the center of the middle zone 12a when the car 1 is positioned so as to correspond to the position of the standard floor. The lower zone 12b linearly extends downward from a lower end of the middle zone 12a. The upper zone 12c linearly extends upward from an upper end of the middle zone 12a.

A scheme to be used by the sensor 13 to detect the correction plate 12 may be a magnetic scheme, an optical scheme, or a mechanical scheme. The sensor 13 is required to have a function of being able to detect the middle zone 12a, the lower zone 12b, and the upper zone 12c in a distinguished manner.

To implement this function, a plurality of plates for each zone may be provided as the correction plate 12. Identification information that can be detected by the sensor 13 may be provided to each of the plurality of plates. The plurality of plates may be placed while positions are shifted in a vertical direction or a horizontal direction instead of the identification information being provided. As another example, the sensor 13 may include a plurality of detection elements that are vertically arranged.

The sensor 13 transmits a signal in accordance with the detected zone to the controller 6.

FIG. 3 is a view for explaining functions of the controller 6. As illustrated in FIG. 3, the controller 6 further includes a reception unit 21, a reception unit 22, a setting unit 23, a calculation unit 24, and a motion control unit 25 in addition to the storage unit 20. The reception unit 21, the reception unit 22, the setting unit 23, and the calculation unit 24 may be included in another device different from the controller 6, such as a safety controller, in the present system.

The reception unit 21 receives a signal from the sensor 11. The reception unit 22 receives a signal from the sensor 13.

An example where the table TA is stored in the storage unit 20 will be described in detail below. In other words, as indicated in the table TA, the first floor that is the lowest service floor is set as the standard floor. A standard position code is a code set in advance as a code indicating a position of the standard floor among the position codes attached to the tape 8. In the example described below, the standard position code is a position code “5000” indicating a position of the first floor.

The setting unit 23 sets a correction amount for the standard position code. In the following description, the correction amount for the standard position code will be also referred to as a standard correction amount. The calculation unit 24 calculates a correction amount for each position code attached to the tape 8 on the basis of the standard correction amount set by the setting unit 23. The motion control unit 25 controls movement of the car 1 on the basis of the position codes read by the sensor 11 and the correction amounts calculated by the calculation unit 24. Movement control of the car 1 includes at least speed control or position control of the car 1.

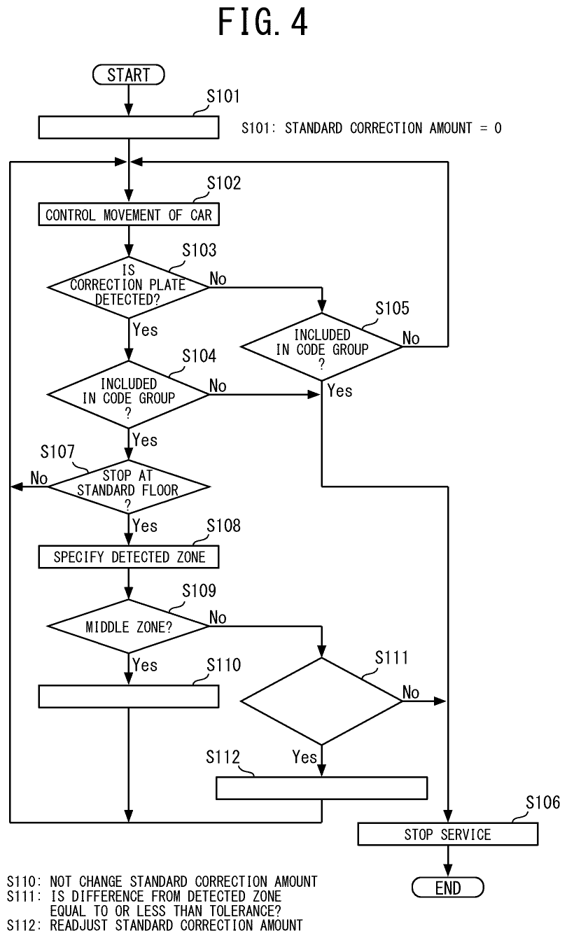

Operation of the present system will be described in detail below also with reference to FIG. 4 to FIG. 7. FIG. 4 is a flowchart indicating an operation example of the elevator system in the first embodiment.

If manual operation by an engineer is performed, and the table TA is newly created or updated, the standard correction amount is set at 0 (S101).

As described above, the motion control unit 25 controls movement of the car 1 on the basis of the position codes read by the sensor 11 and the correction amounts calculated by the calculation unit 24 (S102). The motion control unit 25 calculates a current position of the car 1 from expression (1).

$$[ current position of car 1 ] = [ APS detection position ] + [ correction amount ] \qquad ( 1 )$$

In expression (1), “APS detection position” is a position indicated by the position code read by the sensor 11. The “correction amount” is the correction amount calculated by the calculation unit 24 and is a correction amount for the position code read by the sensor 11. As one example, the correction amount is calculated from a function f (APS detection position, standard correction amount) of the APS detection position and the standard correction amount.

Note that if the standard correction amount is 0, the correction amount is 0. In such a case, the motion control unit 25 performs movement control of the car 1 using the position indicated by the position code read by the sensor 11 as the current position of the car 1. For example, to stop the car 1 at the second floor, the motion control unit 25 stops the car 1 at a position at which the sensor 11 reads the position code “9000”.

While a service by the car 1 is provided by the motion control unit 25, the controller 6 determines whether or not the correction plate 12 is detected by the sensor 13 (S103). While the service is provided, the motion control unit 25 controls movement of the car 1 on the basis of the position codes read by the sensor 11 and causes the car 1 to respond to a registered call. Basically, when the car 1 stops at the standard floor, the correction plate 12 is detected by the sensor 13. Further, when the car 1 passes through the standard floor, the correction plate 12 is detected by the sensor 13. By this means, it is determined as Yes in S103.

If it is determined as Yes in S103, it is determined whether or not the position code read by the sensor 11 is included in a specific code group CG (S104). The code group CG is set in advance. The code group CG includes a plurality of position codes that are vertically consecutive. Further, the code group CG includes the standard position code. As one example, position codes present in a range of “position indicated by standard position code±determination distance” are included in the code group CG. The determination distance preferably satisfies the following expression in a case where an entire length of the correction plate 12 is set as L0.

$$L 0 / 2 \leq [ determination distance ] \leq L 0$$

If the position code not included in the code group CG is read by the sensor 11 although the correction plate 12 is detected by the sensor 13, it is determined as No in S104. If it is determined as No in S104, the motion control unit 25 stops the service by the car 1 after stopping the car 1 at the closest floor or a destination floor (S106). By this means, the car 1 does not respond to a call. The motion control unit 25 may break a safety circuit and stop supply of power to the traction machine 5 to stop the service in S106.

If the correction plate 12 is not detected by the sensor 13, it is determined as No in S103. If it is determined as No in S103, it is determined whether or not the position code read by the sensor 11 is included in the code group CG (S105). If it is determined as No in S105, the service by the car 1 is continued, and the processing returns to S102.

If the position code included in the code group CG is read by the sensor 11 although the correction plate 12 is not detected by the sensor 13, it is determined as Yes in S105. If it is determined as Yes in S105, the motion control unit 25 stops the service by the car 1 in S106.

S103 to S105 indicate processing for determining whether or not a specific stop condition is satisfied. The stop condition is a condition for stopping the service and set in advance. In other words, in the example indicated in FIG. 4, in a case where it is determined as No in S104, the stop condition is satisfied. This indicates an example where the stop condition is satisfied as a result of a signal indicating that the correction plate 12 has been detected being input from the sensor 13 although the car 1 is located at a position away from the standard floor. Further, in the example indicated in FIG. 4, in a case where it is determined as Yes in S105, the stop condition is satisfied. This indicates an example where the stop condition is satisfied as a result of a signal indicating that the correction plate 12 has been detected being not input from the sensor 13 although the car 1 is located at a position sufficiently close to the standard floor.

If the sensor 11 reads the position code included in the code group CG when the correction plate 12 is detected by the sensor 13, it is determined as Yes in S104. If it is determined as Yes in S104, it is determined whether or not the car 1 is stopped at the standard floor (S107). If the car 1 passes through the standard floor, it is determined as No in S107. If it is determined as No in S107, the processing returns to S102.

If the car 1 stops at the standard floor, it is determined as Yes in S107. For example, if the position code read by the sensor 11 does not change for a fixed period or even if the position code changes, an amount of the change is minute, it is determined as Yes in S107. If it is determined as Yes in S107, processing for setting the standard correction amount is started. Specifically, the setting unit 23 sets a standard correction amount on the basis of a detection result of the correction plate 12 by the sensor 13 when the car 1 stops at the standard floor by control by the motion control unit 25.

First, the setting unit 23 specifies a zone detected by the sensor 13 (S108). Then, the setting unit 23 determines whether or not the specified zone is the middle zone 12a (S109).

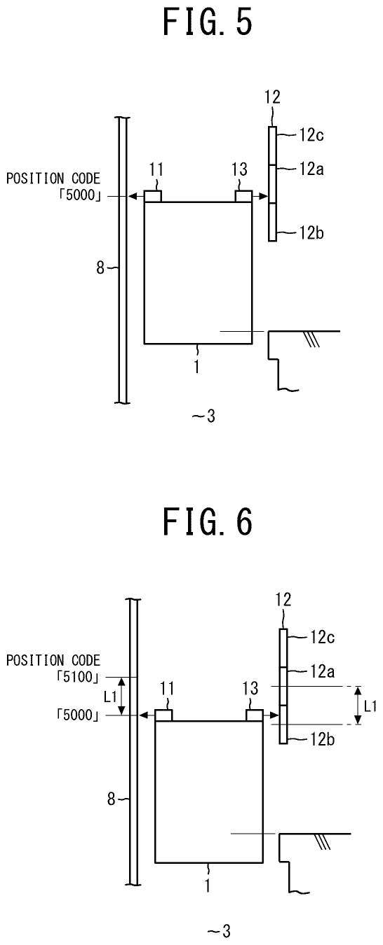

As described above, if the standard correction amount is 0, the correction amount is 0. In such a case, the motion control unit 25 stops the car 1 at a position at which the sensor 11 reads the position code “5000”. In a case where the car 1 stops at the standard floor, that is, the first floor by control by the motion control unit 25, the floor surface of the car 1 is not necessarily positioned at completely the same height as the floor surface of the hall of the first floor. For example, there is a case where the tape 8 may elongate due to factors such as temperature change. In such a case, if the car 1 stops at the first floor by control by the motion control unit 25, the floor surface of the car 1 is positioned at a position lower than the floor surface of the hall of the first floor. FIG. 5 is a view illustrating a condition where the car 1 is stopped at the standard floor. FIG. 5 illustrates a condition where the car 1 is positioned at a position slightly lower than the position of the first floor.

In the example illustrated in FIG. 5, the setting unit 23 specifies that the sensor 13 has detected the middle zone 12a in S108. By this means, it is determined as Yes in S109. If it is determined as Yes in S109, the setting unit 23 does not change the standard correction amount from a current value (S110). In other words, if the sensor 13 detects the middle zone 12a when the car 1 is stopped at the standard floor by control by the motion control unit 25, the setting unit 23 does not change the standard correction amount.

FIG. 6 is a view illustrating another condition where the car 1 is stopped at the standard floor. FIG. 6 illustrates a condition where the car 1 is positioned at a position further lower than the position in the condition illustrated in FIG. 5. In the example illustrated in FIG. 6, the setting unit 23 specifies that the sensor 13 has detected the lower zone 12b in S108. By this means, it is determined as No in S109. Note that the determination indicated in S111 will be described in detail later. In a case where three zones of the middle zone 12a, the lower zone 12b, and the upper zone 12c are set in the correction plate 12, it is always determined as Yes in Sill. If it is determined as No in S109, the setting unit 23 readjusts the standard correction amount (S112).

For example, if the setting unit 23 specifies that the sensor 13 has detected the lower zone 12b in S108, the setting unit 23 changes a standard correction value so that the stop position of the car 1 on the standard floor becomes higher than the current stop position by a distance L1. The distance L1 is a distance in accordance with a distance between the middle zone 12a and the lower zone 12b. As one example, the distance L1 is set at a distance between the center of the middle zone 12a and the center of the lower zone 12b.

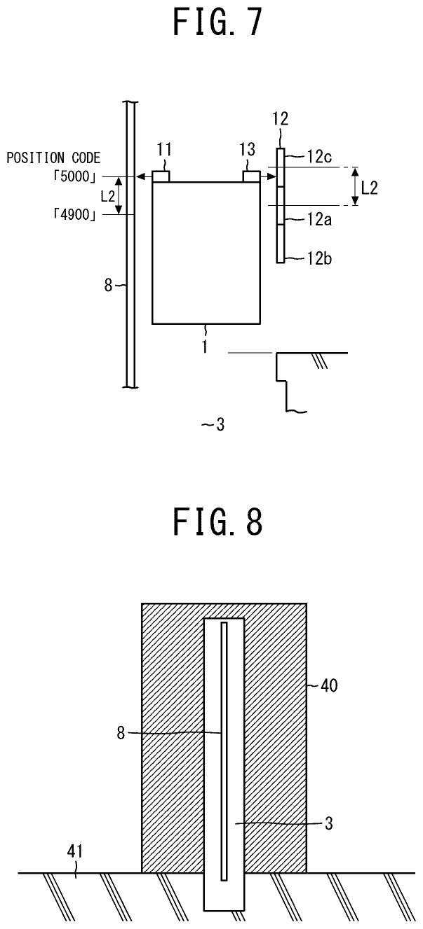

FIG. 7 is a view illustrating another condition where the car 1 is stopped at the standard floor. FIG. 7 illustrates a condition where the car 1 is positioned at a position higher than the position of the first floor as a result of the tape 8 shrinking due to factors such as temperature change. In the example illustrated in FIG. 7, the setting unit 23 specifies that the sensor 13 has detected the upper zone 12c in S108. By this means, it is determined as No in S109. For example, if the setting unit 23 specifies that the sensor 13 has detected the upper zone 12c in S108, the setting unit 23 changes the standard correction value so that the stop position of the car 1 on the standard floor becomes lower than the current stop position by a distance L2. The distance L2 is a distance in accordance with a distance between the middle zone 12a and the upper zone 12c. As one example, the distance L2 is set at a distance between the center of the middle zone 12a and the center of the upper zone 12c. The distance L2 may be the same as or different from the distance L1.

If the standard correction amount is readjusted in S112, the calculation unit 24 calculates a correction amount for each position code attached to the tape 8 on the basis of the readjusted standard correction amount. Each stop position code is also one of the position codes attached to the tape 8, and thus, the correction amount for each of the stop position codes is calculated by the calculation unit 24 as well. As one example, the calculation unit 24 calculates each correction amount so that the correction amount for each position code is proportional to a distance from an upper end of the tape 8. Note that the correction amount for the top is 0, and the correction amount for the standard position code is the standard correction amount. Table 2 indicates an example where the car 1 is stopped at the standard floor in the condition illustrated in FIG. 6, and the standard correction amount is set at “−100” in terms of position code in S112.

TABLE 2

| Floor | Stop position code | Correction amount |
|---|---|---|
| (Top) | 102000 | 0 |
| N-th floor (top floor) | 100000 | −2 |
| . | . | . |
| . | . | . |
| . | . | . |
| Second floor | 9000 | −94 |
| First floor | 5000 (Standard | −100 |
| (standard floor) | position code) | |
| (Bottom portion) | 3000 | −102 |

As described above, the motion control unit 25 calculates the current position of the car 1 from expression (1). Thus, in a case where the sensor 11 reads the position code “5000”, the motion control unit 25 calculates a position obtained by adding the correction amount “−100” to the position indicated by this position code, that is, a position indicated by the position code “4900” as the current position of the car 1. To stop the car 1 at the first floor, the motion control unit 25 stops the car 1 in the vicinity of a position at which the sensor 11 reads the position code “5100” so that the position calculated from expression (1) matches the position indicated by the position code “5000” that has already been registered.

In the example indicated in the present embodiment, the standard correction amount for the standard position code is set by the setting unit 23, and the correction amount for each position code attached to the tape 8 is calculated by the calculation unit 24. It is therefore not necessary to provide the correction plate 12 at the position of each service floor to correct the position of the car 1. It is only necessary that the correction plate 12 be provided at one standard floor. Thus, according to the example indicated in the present embodiment, even in a case where the tape 8 elongates or shrinks, the position of the car 1 can be corrected with a simple configuration. Further, it is not necessary to provide the correction plate 12 so as to correspond to the position of each service floor, and thus, an accident that the rope 4, or the like, gets caught on the correction plate 12 upon earthquake, or the like, is less likely to occur.

Other functions that can be employed by the present elevator system will be described below. The elevator system may employ the following plurality of functions in combination if possible.

The motion control unit 25 may forcibly stop the car 1 at the standard floor if a fixed period has progressed since the car 1 had stopped at the standard floor last time so that processing for setting the standard correction amount is regularly performed. The fixed period is set in advance.

In the present embodiment, an example where three zones are set in the correction plate 12 has been described. As described above, four or more zones may be set in the correction plate 12. For example, in a case where five zones are set in the correction plate 12, a lowest zone immediately below the lower zone 12b, and an uppermost zone immediately above the upper zone 12c are further set in the correction plate 12 in addition to the middle zone 12a, the lower zone 12b and the upper zone 12c.

In such a case, if it is determined as No in S109 in FIG. 4, it is determined in S111 whether or not a difference from the detected zone is equal to or less than a tolerance. As one example, if it is specified in S108 that the sensor 13 has detected the lower zone 12b or the upper zone 12c, it is determined as Yes in S111. If it is specified in S108 that the sensor 13 has detected the lowest zone or the uppermost zone, it is determined as No in S111. If it is determined as No in S111, the motion control unit 25 stops the service by the car 1 in S106.

In the present embodiment, an example where the first floor that is the bottom floor is set as the standard floor has been described. The standard floor does not have to be the bottom floor.

As a result of investigation by the applicant, it has been found that in a case where only one standard floor is set, the standard floor is preferably set at a service floor present in a range from 11 to 17 from the lower end of the tape 8 among the service floors at which the car 1 stops in a case where the entire length of the tape 8 is set at 100. Further, it has been found that in a case where the service floor is not present in the range, the standard floor is preferably set at a service floor present in a range from 0 to 21 from the lower end of the tape 8. The reason will be described below also with reference to FIG. 8 to FIG. 26.

Note that the upper end of the tape 8 is preferably positioned slightly above the position of the top floor, and the lower end of the tape 8 is preferably positioned slightly below the position of the bottom floor. Compared to a distance from the top floor to the bottom floor, a distance at which the tape 8 projects upward from the position of the top floor and a distance at which the tape 8 projects downward from the position of the bottom floor are extremely small. Thus, the entire length of the tape 8 may be regarded as a distance from the top floor to the bottom floor. In description regarding FIG. 8 to FIG. 26, it is assumed that the entire length of the tape 8 is synonymous with the distance from the top floor to the bottom floor.

FIG. 8 is a view for explaining transmission of heat in the shaft 3. As illustrated in FIG. 8, a building 40 is located at land 41. The shaft 3 is a space which is formed inside the building 40 and which longitudinally extends. The shaft 3 is formed so as to extend below the ground. The tape 8 is hung from the top of the shaft 3.

The building 40 is exposed to an outside air. Thus, a temperature of a portion formed inside the building 40 among the shaft 3 is affected by a temperature of the outside air. On the other hand, a bottom portion of the shaft 3 has contact with the land 41. Heat capacity of the land 41 is extremely greater compared to heat capacity of the building 40. Thus, a temperature of the portion of the shaft 3 is less affected by the temperature of the outside air and is close to a temperature of the land 41. Thus, the temperature of the shaft 3 has inclination in accordance with the temperature of the outside air in a height direction. The tape 8 elongates and shrinks in accordance with the temperature. Thus, in a case where the position of the car 1 is detected on the basis of the position codes attached to the tape 8, correction is preferably performed while elongation and shrinkage of the tape 8 are taken into account.

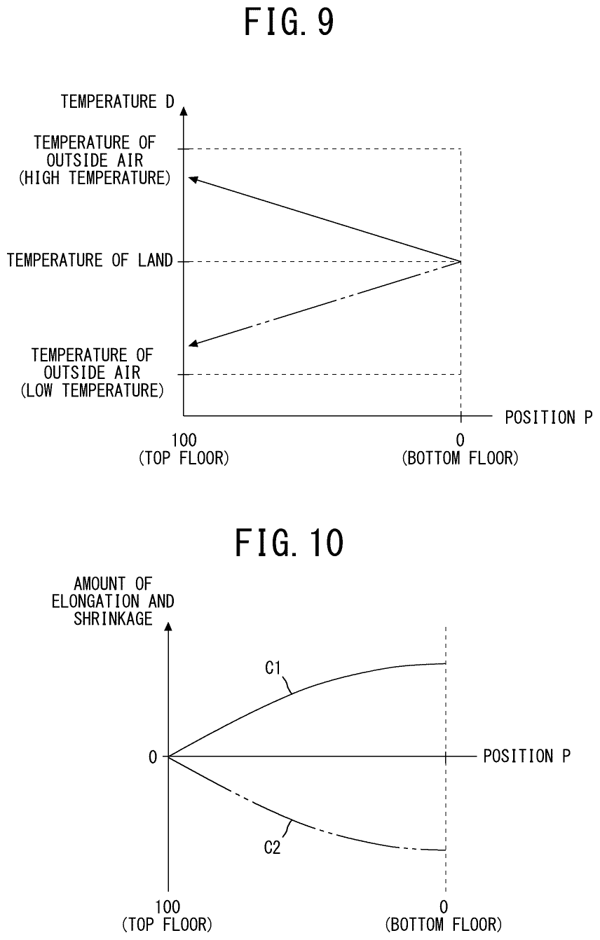

FIG. 9 is a view for explaining temperature distribution of the shaft 3. FIG. 9 indicates a temperature D of the shaft 3 on a vertical axis. FIG. 9 indicates a position P in the shaft 3 on a horizontal axis. Concerning the position P, a position of the bottom floor is set at 0, and a position of the top floor is set at 100. Further, concerning notation of the position P, a normalized numerical value is indicated in brackets. For example, a position P[0] indicates the position of the bottom floor. A position P[100] indicates the position of the top floor. A position P[30] is a position at 30 from the bottom floor in a case where the position of the bottom floor is set at 0, and the position of the top floor is set at 100. FIG. 9 indicates the position of the top floor on a left side and the position of the bottom floor on the right side on the horizontal axis.

As indicated in FIG. 9, the temperature D of the position P[0] is the temperature of the land 41. On the other hand, the heat capacity of the building 40 is smaller than the heat capacity of the land 41, and thus, the temperature D monotonously increases or monotonously decreases toward the top floor. For example, in a case where the temperature of the outside air is higher than the temperature of the land 41, the temperature D becomes higher toward the top floor as indicated with a solid arrow in FIG. 9. In a case where the temperature of the outside air is lower than the temperature of the land 41, the temperature D becomes lower toward the top floor as indicated with a dash-double-dot arrow in FIG. 9.

FIG. 10 is a view for explaining an amount of elongation and shrinkage of the tape 8. In a case where the temperature D of the shaft 3 linearly changes with respect to the position P as indicated in FIG. 9, elongation and shrinkage characteristics of the tape 8 are as indicated in FIG. 10. Specifically, the amount of elongation and shrinkage of the tape 8 is 0 at the position P[100]. In a case where the temperature of the outside air is higher than the temperature of the land 41, the amount of elongation and shrinkage of the tape 8 becomes greater toward the bottom floor as indicated by a curve C1 in FIG. 10. Note that the curve C1 is a curve that is convex upward, and the curve C1 has a center of curvature on a lower side. In a case where the temperature of the outside air is lower than the temperature of the land 41, the amount of elongation and shrinkage of the tape 8 becomes smaller toward the bottom floor as indicated by a curve C2 in FIG. 10. The curve C2 is a curve that is convex downward, and the curve C2 has a center of curvature on an upper side.

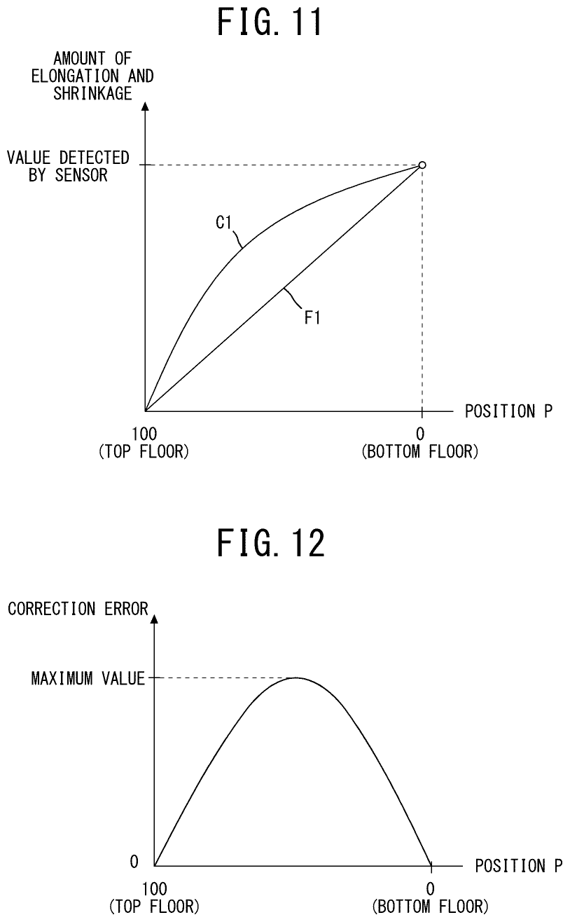

FIG. 11 is a view for explaining an example of a correction function. The curve C1 indicated in FIG. 11 is the same as the curve C1 indicated in FIG. 10. FIG. 11 corresponds to a graph to which a correction function F1 is added to the curve C1 indicated in FIG. 10. FIG. 11 indicates an example where the amount of elongation and shrinkage of the tape 8 at the bottom floor is detected by a sensor. The sensor is a sensor corresponding to the sensor 13. In other words, in the example indicated in FIG. 11, the amount of elongation and shrinkage of the tape 8 at the top floor is 0, and the amount of elongation and shrinkage of the tape 8 at the bottom floor is a value detected by the sensor. The correction function F1 defines a line connecting the amount of elongation and shrinkage at the top floor and the amount of elongation and shrinkage at the bottom floor, that is, the value detected by the sensor as a linear function.

As can be seen from the curve C1, the amount of elongation and shrinkage of the tape 8 becomes a maximum at the bottom floor. Thus, in the example indicated in FIG. 11, the amount of elongation and shrinkage of the tape 8 is detected at a position at which the amount of elongation and shrinkage becomes the maximum. FIG. 12 is a view indicating a difference between the curve C1 and the line indicating the correction function F1 indicated in FIG. 11. In the following description, the difference will be also referred to as a correction error. In the example indicated in FIG. 12, the correction error is always a positive value. Further, the correction error at the top floor and the correction error at the bottom floor are 0. A curve indicating the correction error is a curve that is convex upward, and a peak of the mountain shape becomes a maximum value of the correction error.

The correction error is directly linked to an error of the stop position of the car 1 and thus is preferably as small as possible. Further, polarity of the correction error does not have to be fixed. An example will be described below where the maximum value of the correction error is made smaller by the correction errors mixedly including positive values and negative values.

FIG. 13 is a view for explaining another example of the correction function. The curve C1 indicated in FIG. 13 is the same as the curve C1 indicated in FIG. 10. FIG. 13 corresponds to a graph to which a correction function F2 is added to the curve C1 indicated in FIG. 10. FIG. 13 indicates an example where the amount of elongation and shrinkage of the tape 8 at the position P[n] is detected by the sensor. n is greater than 0 and smaller than 100. For example, n=15. In the example indicated in FIG. 13, the amount of elongation and shrinkage of the tape 8 at the top floor is 0, and the amount of elongation and shrinkage of the tape 8 at the position P[n] is a value detected by the sensor. The correction function F2 defines a line connecting the amount of elongation and shrinkage at the top floor and the amount of elongation and shrinkage at the position P[n], that is the value detected by the sensor as a linear function.

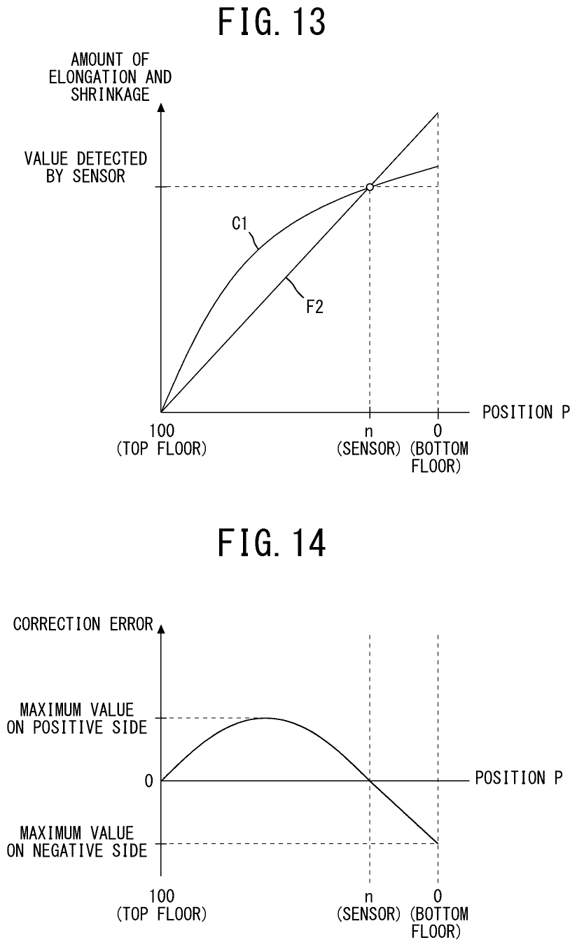

FIG. 14 is a view indicating a difference between the curve C1 and the line indicating the correction function F2 indicated in FIG. 13. In the example indicated in FIG. 14, the correction error at the position P[n] is 0. The correction error from the position P[0] to the position P[n] is a negative value. The correction error from the position P[100] to the position P[n] is a positive value. In this manner, by making the detection position by the sensor higher than the bottom floor, it is possible to make a maximum value of an absolute value of the correction error smaller. The detection position by the sensor is preferably set so that an absolute value of a maximum value on a positive side of the correction error becomes equal to an absolute value of a maximum value on a negative side (minimum value).

A result obtained by the applicant performing investigation based on data acquired from actual elevator devices will be described next.

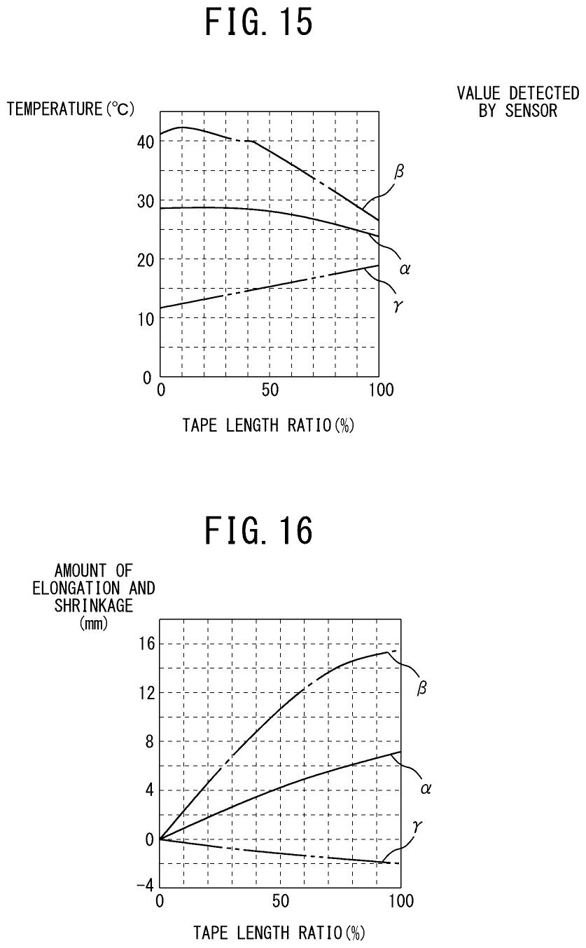

FIG. 15 is a view indicating temperature distribution of the shaft 3 measured in the actual elevator devices. FIG. 15 indicates a length of the tape 8 from the top floor on a horizontal axis, which is indicated with a ratio with respect to the entire length of the tape 8. For example, a value of the ratio at the top floor is 0, and a value of the ratio at the bottom floor is 100. Notation on the horizontal axis in FIG. 15 is substantially the same as the notation on the horizontal axes from FIG. 9 to FIG. 14.

In FIG. 15, a solid line indicates temperature data measured in summer in the shaft 3 formed in an actually existing building α. In the building α, a range in which the car 1 can move is less than 200 m. An alternate-long-and-short-dash line indicates temperature data measured in summer in the shaft 3 formed in an actually existing building β. In the building β, a range in which the car 1 can move is greater than 200 m. A dash-double-dot line indicates temperature data measured in winter in the shaft 3 formed in an actually existing building γ. In the building γ, a range in which the car can move is less than 40 m.

FIG. 16 is a view indicating an amount of elongation and shrinkage of the tape 8 calculated from the temperature distribution indicated in FIG. 15. FIG. 16 indicates a result of calculating an amount Δl [m] of elongation and shrinkage using expression (2).

$$Δ l = l \times G \times Δ T \qquad ( 2 )$$

Here, l is a length of the tape 8, G [1/K] is a temperature elasticity coefficient, and ΔT [K] is a temperature difference. To obtain the result indicated in FIG. 16, actually, the temperature data of the shaft 3 was measured at a plurality of heights, and a temperature at each tape length ratio was obtained using linear interpolation. Further, concerning the temperature difference ΔT, a difference from 25 degrees Celsius was calculated.

As indicated in FIG. 15, a temperature at the bottom floor of the shaft 3, that is, at the tape length ratio of 100% is from 19 to 26° C. which is substantially ordinary temperature in all buildings. In the building α and the building β, the temperature data was acquired in summer, and thus, the temperature of the shaft 3 tends to be higher toward the top floor. In the building γ, the temperature data was acquired in winter, and thus, the temperature of the shaft 3 tends to be lower toward the top floor. It can be seen from FIG. 16 that the amount of elongation and shrinkage of the tape 8 monotonously increases in summer and monotonously decreases in winter. Further, it can be seen that the tape 8 elongates and shrinks in accordance with the temperature of the shaft 3, and thus, it is necessary to perform correction in accordance with elongation and shrinkage.

First, a case will be considered where the amount of elongation and shrinkage of the tape 8 at the bottom floor is detected by the sensor. FIG. 17 is a view for explaining an example of the correction function. Three curves indicated in FIG. 17 are the same as the three curves indicated in FIG. 16. FIG. 17 corresponds to a graph to which correction functions are respectively added to the three curves indicated in FIG. 16 in a similar manner to the example indicated in FIG. 11. A correction function Fα is a correction function for a curve indicating the amount of elongation and shrinkage of the tape 8 provided in the building α. A correction function Fβ is a correction function for a curve indicating the amount of elongation and shrinkage of the tape 8 provided in the building β. A correction function Fγ is a correction function for a curve indicating the amount of elongation and shrinkage of the tape 8 provided in the building γ.

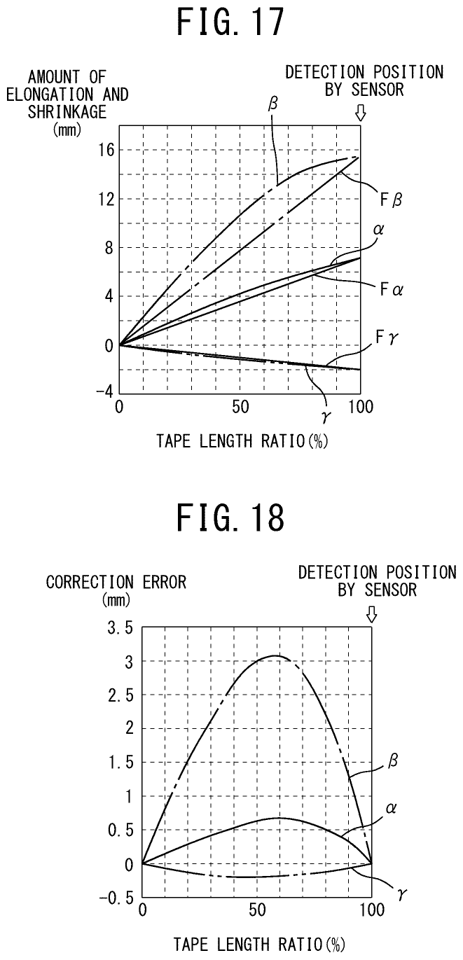

FIG. 18 is a view indicating an example of the correction error. FIG. 18 corresponds to a graph obtained by calculating the correction error in a similar manner to the example indicated in FIG. 12 on the basis of the example indicated in FIG. 17. In other words, a solid curve indicated in FIG. 18 represents a difference between the solid curve indicated in FIG. 17 and a line indicating the correction function Fα. An alternate-long-and-short-dash curve indicated in FIG. 18 represents a difference between the alternate-long-and-short-dash curve indicated in FIG. 17 and a line indicating the correction function Fβ. A dash-double-dot curve indicated in FIG. 18 represents a difference between the dash-double-dot curve indicated in FIG. 17 and a line indicating the correction function Fγ.

The solid curve and the alternate-long-and-short-dash curve indicated in FIG. 18 are curves that are convex upward, and the correction error is always a positive value. On the other hand, the dash-double-dot curve indicated in FIG. 18 is a curve that is convex downward, and the correction error is always a negative value. It is therefore possible to make a maximum value of an absolute value of the correction error smaller by making the detection position by the sensor higher than the bottom floor so that the correction error mixedly includes positive values and negative values. An appropriate range of the detection position by the sensor will be studied below for each building.

### [Building α]

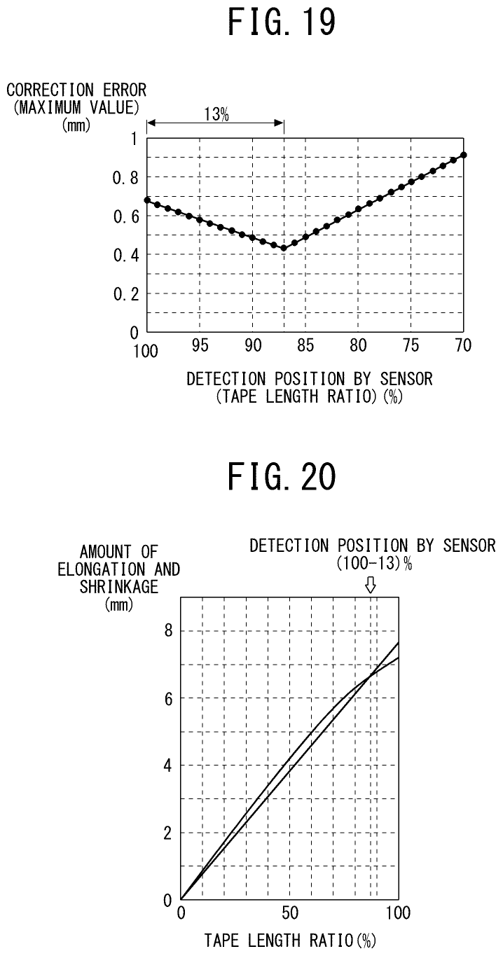

FIG. 19 is a view indicating a relationship between the detection position by the sensor and the maximum value of the absolute value of the correction error. As indicated in FIG. 19, the maximum value of the absolute value of the correction error becomes a minimum in a case where the detection position by the sensor is located at 13 from the lower end of the tape 8 in a case where the entire length of the tape 8 is set at 100. The minimum value is reduced to approximately 64% compared to the maximum value in a case where the detection position by the sensor is at the bottom floor.

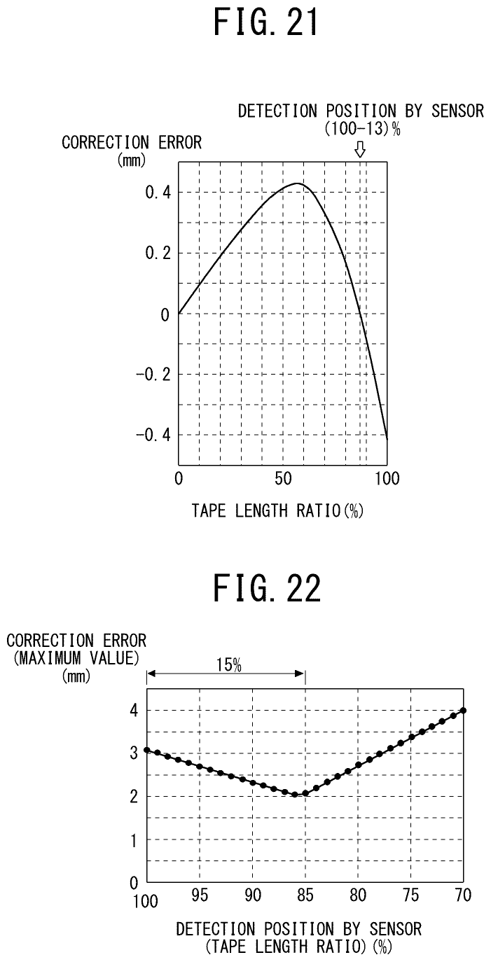

FIG. 20 is a view corresponding to FIG. 13. FIG. 21 is a view corresponding to FIG. 14. In other words, a curve indicated in FIG. 20 is the same as the solid curve indicated in FIG. 17. FIG. 20 indicates an example of the correction function when the detection position by the sensor is at the tape length ratio of 87%. A curve indicated in FIG. 21 represents a difference between the curve and the line indicating the correction function indicated in FIG. 20. As indicated in FIG. 21, polarity of the correction error is inverted at the detection position by the sensor. Further, the absolute value of the maximum value of the correction error is the same as the absolute value of the minimum value.

### [Building β]

FIG. 22 is a view indicating a relationship between the detection position by the sensor and the maximum value of the absolute value of the correction error. FIG. 22 is a view corresponding to FIG. 19. As indicated in FIG. 22, the maximum value of the absolute value of the correction error becomes a minimum in a case where the detection position by the sensor is located at 15 from the lower end of the tape 8 in a case where the entire length of the tape 8 is set at 100. The minimum value is reduced to approximately 66% compared to the maximum value in a case where the detection position by the sensor is at the bottom floor. Also concerning the building β, a view corresponding to FIG. 20 and a view corresponding to FIG. 21 can be obtained in a similar manner.

### [Building γ]

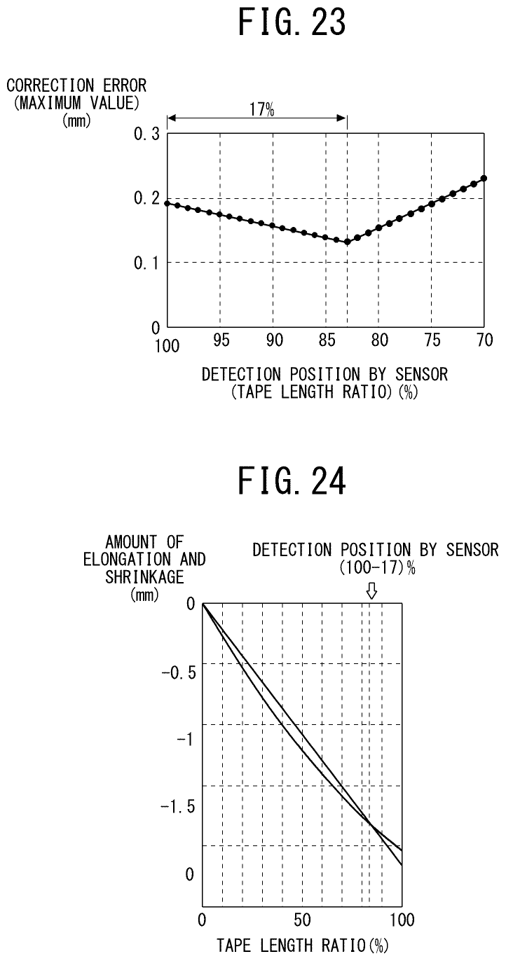

FIG. 23 is a view indicating a relationship between the detection position by the sensor and the maximum value of the absolute value of the correction error. As indicated in FIG. 23, the maximum value of the absolute value of the correction error becomes a minimum in a case where the detection position by the sensor is located at 17 from the lower end of the tape 8 in a case where the entire length of the tape 8 is set at 100. The minimum value is reduced to approximately 68% compared to the maximum value in a case where the detection position by the sensor is at the bottom floor.

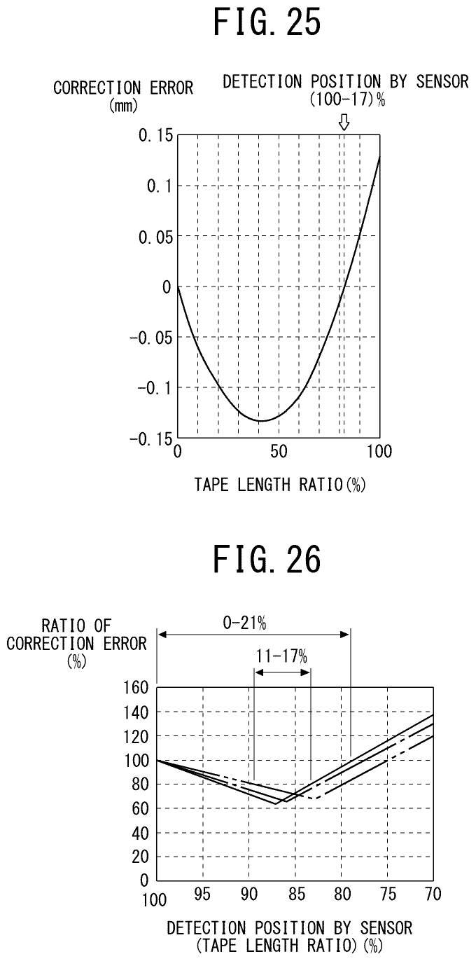

FIG. 24 is a view corresponding to FIG. 13. FIG. 25 is a view corresponding to FIG. 14. In other words, a curve indicated in FIG. 24 is the same as the dash-double-dot curve indicated in FIG. 17. FIG. 24 indicates an example of the correction function when the detection position by the sensor is at the tape length ratio of 83%. A curve indicated in FIG. 25 represents a difference between the curve and the line indicating the correction function indicated in FIG. 24. As indicated in FIG. 25, polarity of the correction error is inverted at the detection position by the sensor. Further, the absolute value of the maximum value of the correction error is the same as the absolute value of the minimum value.

FIG. 26 is a view indicating a ratio of the correction error in each building. On a vertical axis in FIG. 26, when the detection position by the sensor is at the tape length ratio of 100%, that is, when the detection position by the sensor is at the bottom floor, the correction error is set at 100. A solid broken line indicated in FIG. 26 is a broken line corresponding to a broken line indicated in FIG. 19. An alternate-long-and-short-dash broken line indicated in FIG. 26 is a broken line corresponding to a broken line indicated in FIG. 22. A dash-double-dot broken line indicated in FIG. 26 is a broken line corresponding to broken line indicated in FIG. 23.

As indicated in FIG. 26, if the detection position by the sensor falls within a range from 0 to 21 from the lower end of the tape 8 in a case where the entire length of the tape 8 is set at 100, the correction error does not become greater than the correction error in a case where the detection position by the sensor is at the bottom floor. More preferably, if the detection position by the sensor falls within a range from 11 to 17 from the lower end of the tape 8, the correction error becomes smaller than a value that is 80% of the correction error in a case where the detection position by the sensor is at the bottom floor. Thus, the standard floor is preferably a service floor present in the above range. Further, the calculation unit 24 preferably calculates the correction amount using linear interpolation while the standard floor is set at a service floor present in the above range.

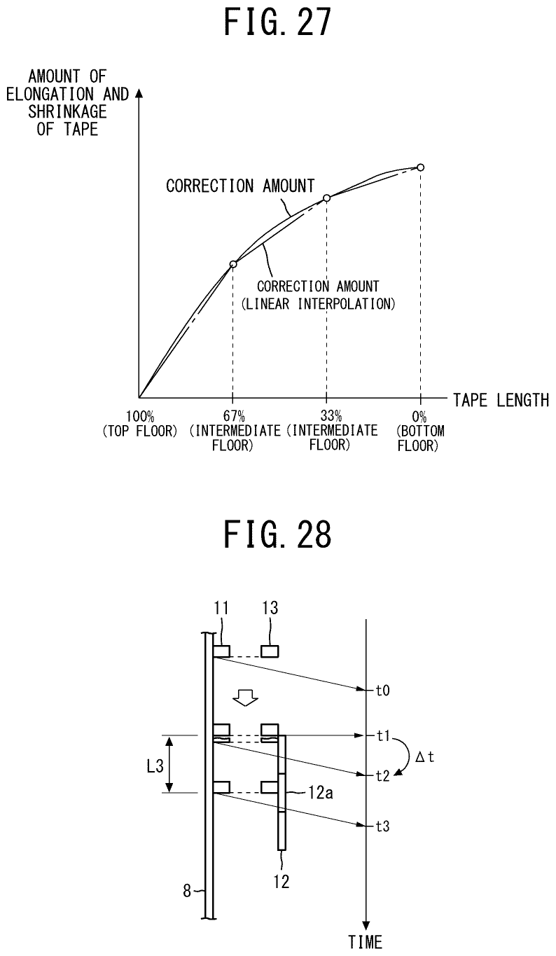

As another example, a plurality of service floors among service floors at which the car 1 stops may be set as the standard floors. A lowest service floor is preferably set as one of the plurality of standard floors. Service floors closest to positions at boundaries in a case where the entire length of the tape 8 is equally divided by the number of the standard floors are preferably set at the remaining plurality of standard floors. In such a case, the setting unit 23 sets a standard correction amount for a standard position code indicating each position of the plurality of standard floors. The calculation unit 24 calculates a correction amount for each position code attached to the tape 8 on the basis of the plurality of standard correction amounts set by the setting unit 23. FIG. 27 is a view indicating a calculation example of the correction amount in a case where three standard floors are set. In a case where a plurality of standard floors are set, the calculation unit 24 preferably calculates a correction amount using quadratic function approximation. Note that in a case where a plurality of standard floors are set, the correction amount may be calculated using linear interpolation.

As another example, in the controller 6, control may be performed while a delay time of a signal from the sensor 11 is taken into account. In such a case, as illustrated in FIG. 3, the controller 6 further includes a provision unit 26 and a calculation unit 27.

As one example, a signal from the sensor 13 is transmitted to the controller 6 through parallel transmission. On the other hand, the signal from the sensor 11 is transmitted to the controller 6 through serial transmission. Thus, a communication delay time Δt occurs in the signal from the sensor 11.

The provision unit 26 provides time information to the signal from the sensor 11. The provision unit 26 provides time information to the signal from the sensor 13. The signal from the sensor 11 and the signal from the sensor 13 to which the time information is provided by the provision unit 26 are stored in the storage unit 20 for a fixed period.

FIG. 28 is a view for explaining a method for calculating the delay time Δt. FIG. 28 illustrates an example where the car 1 that is moving downward stops at the standard floor. The sensor 13 detects an end of the correction plate 12 before the car 1 stops at the standard floor. By the sensor 13 detecting the end of the correction plate 12, the signal from the sensor 13 rises. In other words, if the sensor 13 detects the end of the correction plate 12, the reception unit 22 receives a signal indicating that the sensor 13 has detected the end of the correction plate 12. In the example illustrated in FIG. 28, the provision unit 26 provides time t1 to the signal from the sensor 13 at the time when the sensor 13 has detected the end of the correction plate 12.

After the sensor 13 has detected the end of the correction plate 12, the car 1 stops at the standard floor. The signal from the sensor 11 is transmitted to the controller 6 at a fixed cycle. Thus, a signal indicating the position code read by the sensor 11 when the car 1 stops at the standard floor is also transmitted to the controller 6. In the example illustrated in FIG. 28, the provision unit 26 provides time t3 to the signal from the sensor 11 at the time when the car 1 stops at the standard floor.

The calculation unit 27 calculates a delay time Δt of the signal from the sensor 11 on the basis of the time t1 and the time t3 provided by the provision unit 26. First, the calculation unit 27 calculates an entering distance L3 of the car 1. The entering distance L3 is a movement distance of the car 1 since the sensor 13 has detected the end of the correction plate 12. In a case where the sensor 13 detects the middle zone 12a when the car 1 is stopped, the calculation unit 27 may calculate a distance from the end of the correction plate 12 to the center of the middle zone 12a as the entering distance L3. The calculation unit 27 estimates a position obtained by subtracting the entering distance L3 from the stop position of the car 1 based on the signal from the sensor 11 as a position of the end of the correction plate 12.

As described above, the signal from the sensor 11 is transmitted to the controller 6 at a fixed cycle. Thus, the signal from the sensor 11 is not necessarily transmitted at the same timing as a timing at which the car 1 is positioned at the estimated position. Thus, the calculation unit 27 specifies a signal including a position code indicating a position closest to the estimated position among the signals from the sensor 11 and specifies the time information provided to the specified signal. In the example illustrated in FIG. 28, the calculation unit 27 specifies time t2 as the time information on the basis of the time t3 and the entering distance L3. The calculation unit 27 calculates a delay time Δt from the following expression.

$$Δ t = t 2 - t 1$$

The motion control unit 25 controls movement of the car 1 also on the basis of the delay time Δt calculated by the calculation unit 27. For example, movement control of the car 1 includes speed control and position control of the car 1. For example, current speed and position of the car 1 can be estimated from the following expression.

$$[ speed V ] = [ speed {V}_{APS} ] + [ acceleration {A}_{APS} ] \times [ delay time Δ t ] \\ [ position P ] = [ position {P}_{APS} ] + [ correction amount ] + ( [ speed {V}_{APS} ] + 1 / 2 \times [ acceleration {A}_{APS} ] \times [ delay time Δ t ] ) \times [ delay time Δ t ]$$

Here, the speed V_{APS} is speed calculated on the basis of the signal from the sensor 11. The acceleration A_{APS} is acceleration calculated on the basis of the signal from the sensor 11. The position P_{APS} is a position based on the signal from the sensor 11.

The motion control unit 25 may simply estimate the current speed and position of the car 1 as indicated in the following expression.

$$[ speed V ] = [ speed {V}_{APS} ] \\ [ position P ] = [ position {P}_{APS} ] + [ correction amount ] + [ speed {V}_{APS} ] \times [ delay time Δ t ]$$

In the present embodiment, an example has been described where all the processing is completed in one elevator device provided in the elevator system. In a case where the elevator system includes a plurality of elevator devices, necessary information may be exchanged with each other.

As one example, the above-described elevator device is set as an elevator device A. The elevator system further includes an elevator device B in addition to the elevator device A. The elevator device A and the elevator device B belong to the same bank and have similar configurations and functions. However, the standard floor in the elevator device B is preferably set at a floor different from the standard floor in the elevator device A.

In the following description, to distinguish between the elevator device A and the elevator device B, an alphabetic character A is added in description regarding the elevator device A, and an alphabetic character B is added in description regarding the elevator device B. For example, the elevator device A includes a controller 6A, and the elevator device B includes a controller 6B. A standard floor A is set in the elevator device A, and a standard floor B is set in the elevator device B. As one example, the standard floor B is set at a floor different from the standard floor A.

In this example, the controller 6A further includes a communication unit 28A as illustrated in FIG. 3. The communication unit 28A has a function of communication with the controller 6B. In a similar manner, the controller 6B further includes a communication unit 28B. The communication unit 28B has a function of communicating with the controller 6A. The communication unit 28B transmits a standard correction amount B for a standard position code B, set by the setting unit 23B, to the controller 6A.

The communication unit 28A acquires the standard correction amount B from the elevator device B. A calculation unit 24A calculates a correction amount for each position code attached to the tape 8 not only based on a standard correction amount A set by a setting unit 23A but also the standard correction amount B acquired by the communication unit 28A. The standard position code B is regarded as a code set in advance as a code indicating a position of the standard floor B among the position codes attached to the tape 8A. In this example, the calculation unit 24A can calculate the correction amounts in a similar manner to a case where a plurality of standard floors A are set.

If the elevator system includes three elevator devices, the correction amounts as indicated in FIG. 27 can be calculated even if only one standard floor is set in each elevator device.

Further, all the processing may be completed in one elevator device at normal times, and necessary information may be acquired from other elevator devices in a case where the sensor 13 fails, or the like. For example, if a sensor 13A normally functions, the calculation unit 24A calculates the correction amounts on the basis of the standard correction amount A set by the setting unit 23A. If the sensor 13A fails, the calculation unit 24A may calculate the correction amounts on the basis of the standard correction amount B acquired by the communication unit 28A.

As another example, only part of a plurality of elevator devices belonging to the same bank may include the correction plate 12 and the sensor 13. In the elevator device including the correction plate 12 and the sensor 13, the standard correction amount is set for the standard position code on the basis of a detection result of the correction plate 12 by the sensor 13, and the correction amounts are calculated. In the elevator device not including the correction plate 12 and the sensor 13, the controller 6 acquires information on the standard position code and the standard correction amount for the standard position code from the elevator device including the correction plate 12 and the sensor 13 and calculates the correction amounts.

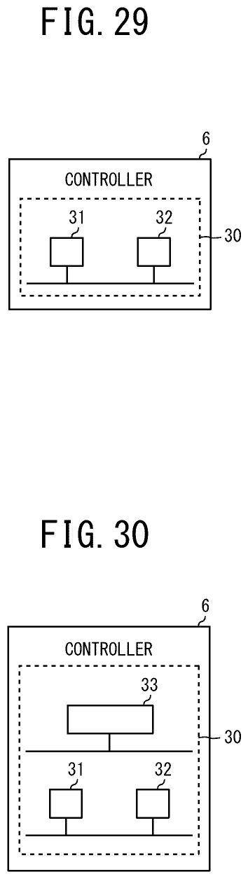

FIG. 29 is a view illustrating an example of hardware resources of the controller 6. The controller 6 includes processing circuitry 30 including a processor 31 and a memory 32 as hardware resources. The processing circuitry 30 may include a plurality of processors 31. The processing circuitry 30 may include a plurality of memories 32.

In the present embodiment, respective units indicated by reference numerals 20 to 28 indicate functions of the controller 6. Functions of the storage unit 20 is implemented by the memory 32. Functions of the respective units indicated by the reference numerals 21 to 28 can be implemented by software described as a program, firmware or combination of software and firmware. The program is stored in the memory 32. The controller 6 implements the functions of the respective units indicated by the reference numerals 21 to 28 by the processor 31 (computer) executing the program stored in the memory 32.

The processor 31 is also referred to as a central processing unit (CPU), a central processing device, a processing device, an arithmetic operation device, a microprocessor, a microcomputer, or a DSP. As the memory 32, a semiconductor memory, a magnetic disk, a flexible disk, an optical disk, a compact disk, a mini disk, or a DVD may be employed. The semiconductor memories that can be employed include a RAM, a ROM, a flash memory, an EPROM, an EEPROM, and the like.

FIG. 30 is a view illustrating another example of the hardware resources of the controller 6. In the example illustrated in FIG. 30, the controller 6 includes the processing circuitry 30 including the processor 31, the memory 32, and dedicated hardware 33. FIG. 30 illustrates an example where part of the functions of the controller 6 is implemented by the dedicated hardware 33. All of the functions of the controller 6 may be implemented by the dedicated hardware 33. As the dedicated hardware 33, a single circuit, a composite circuit, a programmed processor, a parallel programmed processor, an ASIC, an FPGA, or combination thereof can be employed.

### INDUSTRIAL APPLICABILITY

An elevator system according to the present disclosure can be applied to an elevator system including an absolute positioning system.

### REFERENCE SIGNS LIST

1 car, 2 counterweight, 3 shaft, 4 rope, 5 traction machine, 6 controller, 7 machine room, 8 tape, 9 support member, 10 support device, 11 sensor, 12 correction plate, 12a middle zone, 12b lower zone, 12c upper zone, 13 sensor, storage unit, 21 reception unit, 22 reception unit, 23 setting unit, 24 calculation unit, 25 motion control unit, 26 provision unit, 27 calculation unit, 28 communication unit, 30 processing circuitry, 31 processor, 32 memory, 33 dedicated hardware, 40 building, 41 land

1. An elevator system in which a car moves in a shaft, the car stops at a plurality of service floors, and part of the plurality of service floors is set as a standard floor, the elevation system comprising:
a tape which is provided in the shaft and to which position codes are attached over a specific range in which the car can move;
a first sensor which is provided on the car and which reads the position codes attached to the tape;
a detected object provided in the shaft so as to correspond to a position of the standard floor;
a second sensor which is provided on the car and which detects the detected object; and
processing circuitry
to control movement of the car,
to set a standard correction amount for a standard position code on the basis of a detection result of the detected object by the second sensor when the car stops at the standard floor,
to calculate a correction amount for each of the position codes attached to the tape on the basis of the set standard correction amount, and
to control the movement of the car on the basis of the position codes read by the first sensor and calculated correction amounts, wherein
the standard position code is a code set in advance as a code indicating the position of the standard floor among the position codes attached to the tape.

2. The elevator system according to claim 1, wherein
a first zone, a second zone immediately below the first zone, and a third zone immediately above the first zone are set in the detected object,
when the car stops at the standard floor, the processing circuitry is configured
not to change the standard correction amount if the second sensor detects the first zone,
to set the standard correction amount so that a stop position of the car at the standard floor becomes higher than a current stop position by a first distance if the second sensor detects the second zone, and
to set the standard correction amount so that the stop position of the car at the standard floor becomes lower than the current stop position by a second distance if the second sensor detects the third zone,
the first distance is a distance in accordance with a distance between the first zone and the second zone, and
the second distance is a distance in accordance with a distance between the first zone and the third zone.

3. The elevator system according to claim 1, wherein
a code group including a plurality of position codes that are vertically consecutive is set in advance,
the code group includes the standard position code,
the processing circuitry is configured to stop a service by the car if a specific stop condition is satisfied, and
the stop condition
is satisfied in a case where a position code not included in the code group is read by the first sensor although the detected object is detected by the second sensor, and
is satisfied in a case where a position code included in the code group is read by the first sensor although the detected object is not detected by the second sensor.

4. The elevator system according to claim 1, wherein
the processing circuitry is configured to stop the car at the standard floor if a fixed period has progressed since the car had stopped at the standard floor last time.

5. The elevator system according to claim 1, wherein the processing circuitry is configured:
to provide time information to a signal from the first sensor and a signal from the second sensor,
to calculate a delay time of the signal from the first sensor on the basis of time information provided to the signal from the second sensor at the time when the second sensor detects an end of the detected object and time information provided to the signal from the first sensor at the time when the car stops at the standard floor, and
to control the movement of the car also on the basis of the calculated delay time.

6. The elevator system according to claim 1, wherein
the standard floor is a service floor present in a range from 11 to 17 from a lower end of the tape among the plurality of service floors in a case where an entire length of the tape is set at 100, and
the processing circuitry is configured to calculate a correction amount using linear interpolation.

7. The elevator system according to claim 1, wherein
a plurality of standard floors are set,
the plurality of standard floors are a lowest service floor and service floors closest to positions of boundaries when an entire length of the tape is equally divided by the number of the standard floors, and
the processing circuitry is configured
to set a standard correction amount for a standard position code indicating each of positions of the plurality of standard floors, and
to calculate a correction amount on the basis of a plurality of set standard correction amounts.

8. The elevator system according to claim 1, wherein
the processing circuitry is configured to acquire a second standard correction amount for a second standard position code from another elevator device in the same bank,
the second standard position code is a code set in advance as a code indicating a position of a second standard floor among the position codes attached to the tape, and
the processing circuitry is configured to calculate a correction amount on the basis of the set standard correction amount and the acquired second standard correction amount.
